(19) United States
(12) Patent Application Publication
(10) Pub. No.: US 2004/0026267 A1
(43) Pub. Date: Feb. 12, 2004

(54) Sensor for determining gases and method of manufacturing same

(76) Inventors: Thomas Brinz, Bissingen Unter Der Teck (DE); Mary Lewis, Gerlingen (DE); Neil McMurray, Swansea Wales (GB)

Correspondence Address: KENYON & KENYON, One Broadway, New York, NY, 10004, US

(21) Appl. No.: 10/376,003

(22) Filed: Feb. 27, 2003

(30) Foreign Application Priority Data
Feb. 28, 2002 (DE) 102 08 648.6

(51) Int. Cl. G01N 27/26

(52) U.S. Cl. 205/780.5; 205/782; 204/424; 29/592.1

(57) ABSTRACT

A sensor is described for determining the concentration of a gas in gas mixtures. The sensor has a measurement electrode and a reference electrode, as well as a polymer layer which is in contact with the gas mixture and the measurement electrode. A pH-sensitive electrode is provided as the measurement electrode.

### FIELD OF THE INVENTION

The present invention relates to a sensor and to a method of manufacturing the sensor and its use.

### BACKGROUND INFORMATION

Optical sensors for determining the carbon dioxide content of air are used in fire detectors, among other devices. Their function is based on the fact that a layer sensitive to carbon dioxide reversibly changes color on contact with the gas to be determined. This color change is detected using a detector, and when the concentration falls below a set minimum value an alarm is triggered. This measurement method is relatively susceptible to contaminants.

A carbon dioxide sensor is known from U.S. Pat. No. 6,241,873 which detects the carbon dioxide content of a surrounding atmosphere by potentiometric methods. The sensor has a measurement electrode and a reference electrode which are applied to a substrate. The measurement electrode is designed as a silver/silver carbonate electrode. The potential of this electrode depends directly on the carbon dioxide concentration in the surroundings. A disadvantage of this measurement method is that carbon-containing electrodes are adversely affected by weather effects, and thus have only low stability. In addition, the sensor is limited to the measurement of carbon dioxide.

### SUMMARY OF THE INVENTION

An object of the present invention is to provide a gas sensor for determining various gases by potentiometric methods which has high stability as well as high sensitivity.

The sensor according to the present invention has the advantage that its electrodes have long-term stability, and that its measurement electrode has high sensitivity to the gas to be determined. This is achieved by using as the measurement electrode a pH-sensitive electrode which detects the pH of a polymer which surrounds it. Such pH electrodes have adequate durability and allow various acidic and basic gases to be determined.

An iridium oxide electrode is particularly suited as a measurement electrode since it is particularly robust with respect to environmental effects, and need not be present in pre-swollen form, as is the case for comparable glass electrodes.

In a particularly advantageous design, the sensor surrounds a polymer which includes a base or an acid, since these result in rapid and effective absorption of the respective acidic or basic gas to be determined. This increases the sensitivity and further reduces the response time of the sensor.

### BRIEF DESCRIPTION OF THE DRAWINGS

FIG. 1 shows a schematic illustration of an embodiment of the sensor according to the present invention, in the top view.

FIG. 2 shows a sectional representation through the sensor illustrated in FIG. 1 along intersection line A-A.

### DETAILED DESCRIPTION

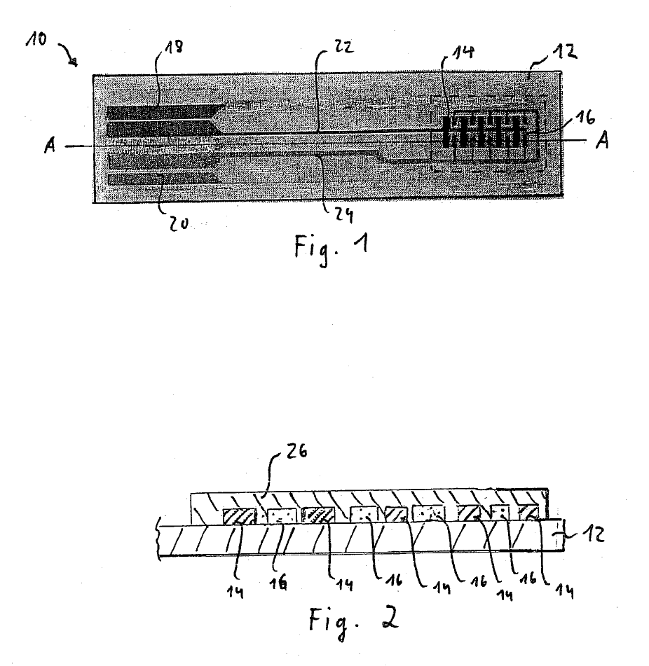

Sensor 10 illustrated in FIGS. 1 and 2 includes a substrate 12 which is preferably made of a ceramic material, for example aluminum oxide. A measurement electrode 14, preferably in the form of an interdigital electrode, is provided on this substrate. This measurement electrode forms a comb-like structure. In addition, a reference electrode 16 is positioned on the substrate and is also preferably designed as an interdigital electrode, the extensions of comb-like reference electrode 16 engaging in the extensions of comb-like measurement electrode 14. This ensures a small distance between measurement and reference electrodes 14, 16, and thus a small impedance of the sensor at electrode surfaces having the same simultaneous height. A common silver/silver chloride electrode is used as the reference electrode, although other electrodes having a constant potential, such as calomel, antimony, or silver/silver bromide electrodes, are also suitable.

Electrodes 14, 16 are connected to contact surfaces 18, 20 via printed conductors 22, 24 which preferably are formed from a curable resin containing a noble metal, such as a silver-containing epoxy resin, for example.

Electrodes 14, 16 preferably are completely coated with a gas-sensitive and gas-permeable polymer layer 26 which functions as an electrolyte and which is represented in FIG. 1 by a dotted-line region. Polymer layer 26 forms a matrix in which the compounds responsible for the sensitivity of the sensor are situated. In one preferred embodiment, polymer layer 26 is composed of a hydrogel or an ethyl cellulose gel. Water is irreversibly bound in these gels.

The operating principle of the sensor is based on the fact that a gas to be determined, carbon dioxide for example, is absorbed by polymer layer 26. The gas dissolves in the bound water in polymer layer 26 and changes the pH of the polymer layer. Since a pH-sensitive electrode is used as measurement electrode 14, the change in pH results in a change in the potential at measurement electrode 14. The change in potential is detectable as a change in voltage between measurement and reference electrodes 14, 16. Measurement electrode 14 may have any design which is suitable for detecting a change in pH in the surroundings with sufficient accuracy. Particularly suitable are conductive metal oxide pH electrodes which for example have a surface layer of mixed iridium oxides (IrOₓ) or ruthenium oxides (RuOₓ). However, platinum and rhodium electrodes are also suitable.

To enable acidic gases present in the air, such as carbon dioxide, nitrogen oxides, or sulfur oxides, which result in an acidic solution upon contact with water, to be absorbed as quickly as possible and in sufficient quantities in polymer layer 26, the polymer layer preferably contains a strong base, for example tetraalkylammonium hydroxides such as tetraoctylammonium hydroxide or tetraalkylammonium hydrogen carbonates. These compounds increase the solubility of the acidic gases in water, which is bound in polymer layer 26, by withdrawing the acid formed during the dissolution process.

For determining basically reacting gases such as ammonia, an acid, a sulfonic acid for example, is preferably added to polymer layer 26. This acid promotes the solubility of basic gases in polymer layer 26. In addition, polymer layer 26 may contain homogenizing agents such as surfactants, for example.

To manufacture sensor 10, an electrode paste preferably containing ceramic and metallic components (cermet) is applied to substrate 12 and sintered with ceramic substrate 12. Polymer layer 26 is applied to the electrode system by applying or printing a solution containing the polymer, a base or an acid, and other additives, and the solvent is removed. The polymer layer has a thickness of 10 μm to 100 μm, preferably between 20 μm and 40 μm.

Electrodes 14, 16 are contacted via printed conductors 22, 24 which are either likewise made of cermet and constructed in one step with electrodes 14, 16, or which are printed with a solution containing a curable resin and a noble metal component and subsequently cured. The use of a silver-containing epoxy resin is preferred.

The present invention is not limited to the embodiment described; rather, other embodiments besides the described sensor are also possible. Thus, for example, an activated carbon layer may be provided on polymer layer 26 to prevent admission of gases such as nitrogen oxides or sulfur oxides which damage polymer layer 26. In addition, a temperature measuring unit, for example, may also be provided to compensate for temperature effects on the measured potential differences.

What is claimed is:

1. A sensor for determining a concentration of a gas in a gas mixture, comprising:
a measurement electrode including a pH-sensitive electrode;
a reference electrode; and
a polymer layer that is in contact with the gas mixture and the measurement electrode.

2. The sensor as recited in claim 1, wherein:
the measurement electrode includes an iridium oxide.

3. The sensor as recited in claim 1, wherein:
the measurement electrode is at least substantially shielded from the gas mixture by the polymer layer.

4. The sensor as recited in claim 1, wherein:
at least one of the measurement electrode and the reference electrode includes an interdigital electrode.

5. The sensor as recited in claim 1, wherein:
the polymer layer includes a base.

6. The sensor as recited in claim 5, wherein:
the base includes a quaternary ammonium compound.

7. The sensor as recited in claim 1, wherein:
the polymer layer includes an acid.

8. The sensor as recited in claim 7, wherein:
the acid includes a sulfonic acid.

9. The sensor as recited in claim 1, wherein:
the polymer layer contains ethyl cellulose.

10. A method of manufacturing a sensor for determining a concentration of a gas in a gas mixture, the sensor including at least two electrodes applied to a ceramic substrate, and a polymer layer, the method comprising:
producing the at least two electrodes on the ceramic substrate by applying an electrode paste and carrying out a subsequent heat treatment; and
applying the polymer layer by applying a polymer solution to at least one of the ceramic substrate and the at least two electrodes and subsequently removing a solvent.

11. The method as recited in claim 10, wherein:
the polymer layer has a thickness of 10 μm to 50 μm.

12. The method as recited in claim 10, further comprising:
contacting the at least two electrodes using a curable polymer containing a noble metal.

13. A method of using a sensor, the sensor including a measurement electrode including a pH-sensitive electrode, a reference electrode, and a polymer layer that is in contact with the gas mixture and the measurement electrode, the method comprising:
using the sensor as a sensitive element in at least one of a fire detector and an air quality sensor.

14. A method of using a sensor, the sensor including a measurement electrode including a pH-sensitive electrode, a reference electrode, and a polymer layer that is in contact with the gas mixture and the measurement electrode, the method comprising:
using the sensor as a sensitive element for detecting ammonia.
